(19) United States
(12) Patent Application Publication
(10) Pub. No.: US 2025/0306345 A1
(43) Pub. Date: Oct. 2, 2025

(54) PROJECTION LENS AND PROJECTION APPARATUS

(71) Applicant: SEIKO EPSON CORPORATION, Tokyo (JP)

(72) Inventors: Akihisa KAGEYAMA, Azumino-shi (JP); Hirotaka YANAGISAWA, Azumino-shi (JP)

(73) Assignee: SEIKO EPSON CORPORATION, Tokyo (JP)

(21) Appl. No.: 19/093,858

(22) Filed: Mar. 28, 2025

(30) Foreign Application Priority Data
Mar. 29, 2024 (JP) 2024-055681

(51) Int. Cl. G02B 13/18; G02B 9/64; G02B 13/16

(52) U.S. Cl. CPC G02B 13/18; G02B 9/64; G02B 13/16

(57) ABSTRACT

A projection lens includes first lens group having positive or negative refractive power; aperture stop; and second lens group having positive refractive power that are sequentially arranged from enlargement side. The first lens group is configured with first sub-lens group having negative refractive index and second sub-lens group having positive refractive index that are sequentially arranged from enlargement side, and projection lens satisfies conditional expressions:

$$\begin{matrix}0.1 < 1 / fg 1 p - 1 / fg 1 m < 0.25 & ( 1 ) \\ ω > 50 & ( 2 ) \\ 2.5 < ( DL 1 \times LL ) \times F / {IH}^{2} < 6.5 & ( 3 ) \\ 3.0 < BF / F < 5.0 & ( 4 )\end{matrix}$$

In Conditional Expressions (1) to (4), value fg1p is the combined focal length of first sub-lens group G1m, value fg1m is the combined focal length of second sub-lens group G1p, value ω is maximum half viewing angle of projection lens, value IH is image circle, value DL1 is the radius of lens closest to a screen, value LL is the total length of projection lens, value F is the combined focal length of all lenses, and value BF is the back focal length in air.

The present application is based on, and claims priority from JP Application Serial Number 2024-055681, filed Mar. 29, 2024, the disclosure of which is hereby incorporated by reference herein in its entirety.

### BACKGROUND

### 1. Technical Field

The present disclosure relates to a projection lens used to enlarge and project an image, and a projection apparatus that incorporates the projection lens.

### 2. Related Art

There is a known projection lens including a first lens group I having negative refractive power and a second lens group II having positive refractive power, the first and second lens groups sequentially arranged from the enlargement side with the widest air gap therebetween in the lens system, the reduction side of the projection lens being substantially a telecentric system, the projection lens having a half viewing angle of 60 degrees or greater (JP-A-2014-190999). In the projection lens, the first lens group includes a group 1A, a group 1B, and a group 1C. The group 1A includes one lens having aspheric surfaces on opposite sides, the group 1B includes a negative meniscus lens having a convex surface facing the enlargement side, a negative lens having large curvature on the reduction side, and a biconcave lens, and the group 1C includes at least one positive lens. The second lens group II includes one lens having an aspherical surface and two sets of three-lens unit lenses, and an aperture stop is disposed in the vicinity of the lens closest to the enlargement side. The three-lens unit lenses are each configured with three lenses brought close to each other or two or more lenses cemented to each other.

JP-A-2014-190999 is an example of the related art.

The projection lens described above has a large lens diameter and a large lens length, which affect the size and weight of a projection apparatus that incorporates the projection lens, and also affect the degree of freedom in appearance design and the degree of freedom in design for ensuring a space when the projection lens is used in a projection apparatus or the like.

### SUMMARY

A projection lens according to an aspect of the present disclosure includes a first lens group having positive or negative refractive power; an aperture stop; and a second lens group having positive refractive power that are sequentially arranged from an enlargement side,
the first lens group is configured with a first sub-lens group having a negative refractive index and a second sub-lens group having a positive refractive index that are sequentially arranged from the enlargement side, and
the projection lens satisfies conditional expressions below,

$$\begin{matrix}0.1 < 1 / fg 1 p - 1 / fg 1 m < 0.25 & ( 1 ) \\ ω > 50 & ( 2 ) \\ 2.5 < ( DL 1 \times LL ) \times F / {IH}^{2} < 6.5 & ( 3 ) \\ 3.0 < BF / F < 5.0 & ( 4 )\end{matrix}$$

In Conditional Expressions (1) to (4), the value fg1p is the combined focal length of the first sub-lens group, the value fg1m is the combined focal length of the second sub-lens group, the value ω is the maximum half viewing angle of the projection lens, the value IH is an image circle, the value DL1 is the effective radius of the lens closest to a screen, the value LL is the total length of the projection lens, the value F is the combined focal length of all the lenses, and the value BF is the back focal length in air.

A projection apparatus according to another aspect of the present disclosure includes: the projection lens described above; and an image forming unit configured to form a projection image in a reduction-side conjugate plane of the projection lens, and the image forming unit includes a light source apparatus and a light modulator configured to modulate light from the light source apparatus.

### BRIEF DESCRIPTION OF THE DRAWINGS

FIG. 1 illustrates a projection apparatus including a projection lens according to an embodiment.

FIG. 2 is a configuration diagram and a beam diagram of the projection lens according to the embodiment.

FIG. 3 illustrates focusing operation performed by the projection lens according to the embodiment.

FIG. 4 illustrates a projection lens according to Example 1.

FIG. 5 shows the characteristics of longitudinal aberrations of the projection lens according to Example 1.

FIG. 6 shows the characteristics of lateral aberrations of the projection lens according to Example 1.

FIG. 7 illustrates a projection lens according to Example 2.

FIG. 8 shows the characteristics of the longitudinal aberrations of the projection lens according to Example 2.

FIG. 9 shows the characteristics of the lateral aberrations of the projection lens according to Example 2.

FIG. 10 illustrates a projection lens according to Example 3.

FIG. 11 shows the characteristics of the longitudinal aberrations of the projection lens according to Example 3.

FIG. 12 shows the characteristics of the lateral aberrations of the projection lens according to Example 3.

### DESCRIPTION OF EMBODIMENTS

### First Embodiment

A projection lens according to an embodiment of the present disclosure and a projection apparatus that incorporates the projection lens will be described below with reference to the drawings.

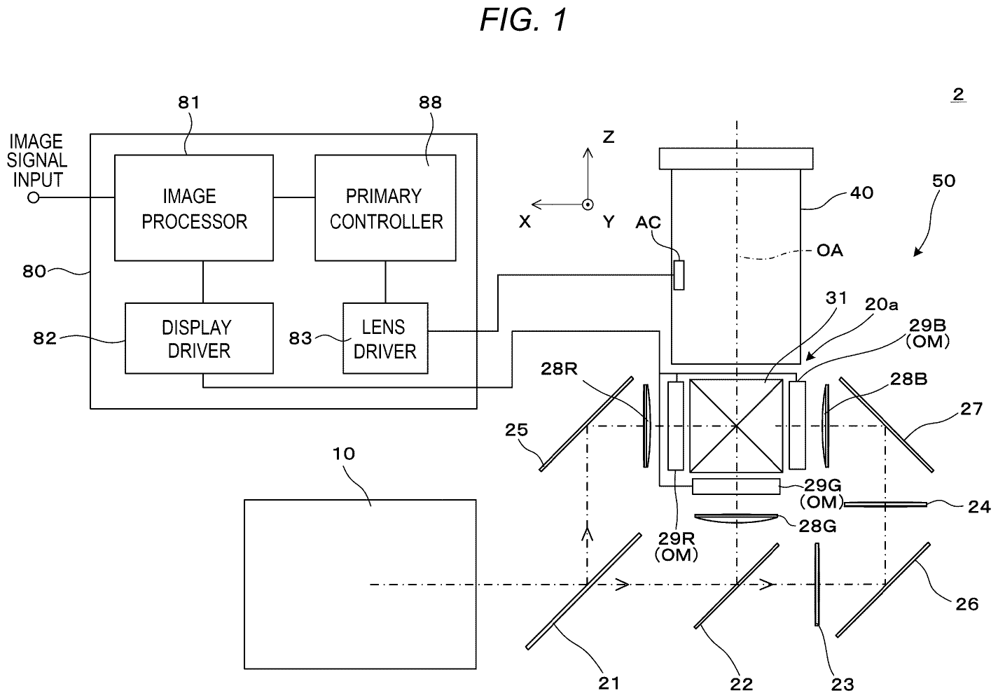

A projection apparatus 2, which incorporates a projection lens 40 according to the embodiment, includes an optical system unit 50, which projects image light, and a circuit apparatus 80, which controls the operation of the optical system unit 50, as shown in FIG. 1.

In the optical system unit 50, a light source apparatus 10 outputs homogenized light containing R light, G light, and B light. The light source apparatus 10 includes a light source lamp that is, for example, an ultrahigh-pressure mercury lamp, a two-stage optical integration lens including multiple lens elements arranged in an array, a polarization converter that converts the light having passed through the two-stage optical integration lens into predetermined linearly polarized light, and a superimposing lens that superimposes illumination light output from a downstream optical integration lens on display regions of liquid crystal panels 29R, 29G, and 29B.

A first dichroic mirror 21 reflects the R light incident from the light source apparatus 10 and transmits the G light and the B light. The R light reflected off the first dichroic mirror 21 enters the liquid crystal panel 29R, which is a light modulator OM, via a reflection mirror 25 and a field lens 28R. The liquid crystal panel 29R modulates the R light in accordance with an image signal to form an R image.

A second dichroic mirror 22 reflects the G light from the first dichroic mirror 21 and transmits the B light. The G light reflected off the second dichroic mirror 22 enters the liquid crystal panel 29G, which is another light modulator OM, via a field lens 28G. The liquid crystal panel 29G modulates the G light in accordance with an image signal to form a G image. The B light having passed through the second dichroic mirror 22 travels via relay lenses 23 and 24, reflection mirrors 26 and 27, and a field lens 28B, and enters the liquid crystal panel 29B, which is another light modulator OM. The liquid crystal panel 29B modulates the B light in accordance with an image signal to form a B image.

A cross dichroic prism 31 is a prism for light combination, and combines the light modulated by the liquid crystal panel 29R, the light modulated by the liquid crystal panel 29G, and the light modulated by the liquid crystal panel 29B with one another into image light, and causes the image light to travel to the projection lens 40.

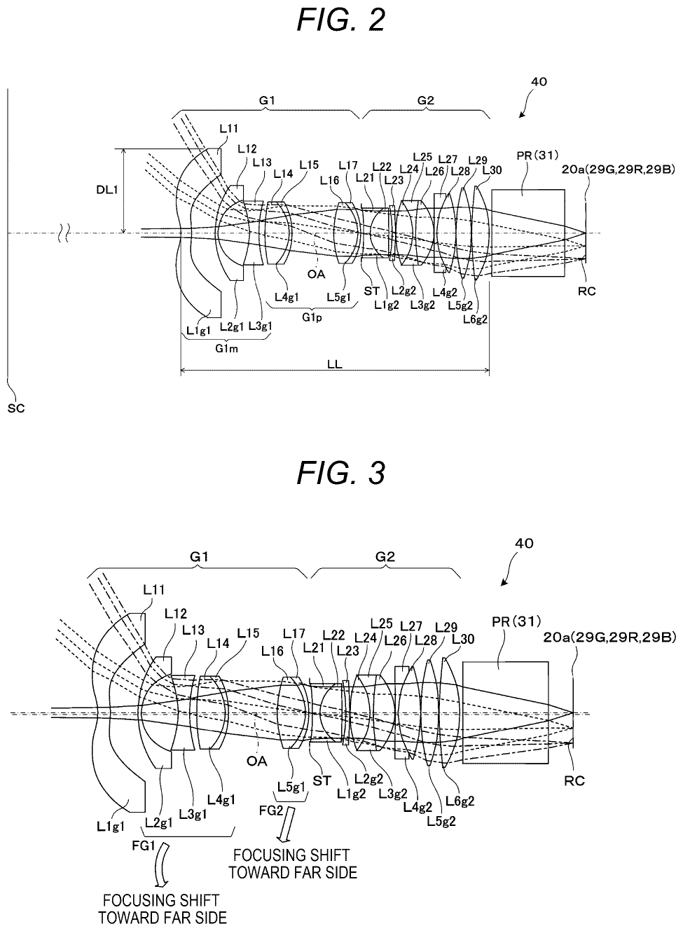

The projection lens 40 is a projection lens that enlarges the multiple types of image light modulated by the liquid crystal panels 29R, 29G, and 29B and combined with one another by the cross dichroic prism 31, and projects the enlarged image light onto a screen SC (see FIG. 2, which will be described later). The liquid crystal panels 29R, 29G, and 29B form an image forming unit 20a, which forms a projection image in a reduction-side conjugate plane RC (see FIG. 2) of the projection lens 40.

The circuit apparatus 80 includes an image processor 81, to which an external image signal such as a video signal is input, a display driver 82, which drives the liquid crystal panels 29R, 29G, and 29B provided in the optical system unit 50 based on an output from the image processor 81, a lens driver 83, which adjusts the state of the projection lens 40 by operating a driving mechanism (not shown) provided in the projection lens 40, and a primary controller 88, which harmoniously controls operation of the circuit sections 81, 82, and 83.

The image processor 81 converts the input external image signal into image signals containing grayscales and other factors of the multiple colors. Note that the image processor 81 can also perform various types of image processing, such as distortion correction and color correction, on the external image signal.

The display driver 82 can operate the liquid crystal panels 29R, 29G, and 29B based on the image signals output from the image processor 81, and can cause the liquid crystal panels 29R, 29G, and 29B to form images corresponding to the image signals or images corresponding to the image signals on which image processing has been performed.

The lens driver 83 operates under the control of the primary controller 88, and can adjust the image formation state of the projection lens 40 by appropriately moving some of optical elements that constitute the projection lens 40 along an optical axis OA via an actuator AC. In this process, lens groups to be moved can be individually moved, or can be moved in coordination with each other by using a cam mechanism. As described above, when the actuator AC is used to electrically change the magnification, the projection lens 40 is smoothly allowed to transition to the in-focus state, and a combination of the actuator AC with a focus sensor (not shown) allows an AF operation of automatically adjusting the focal position in accordance with the location where the projection apparatus 2 is installed and the direction in which the projection apparatus 2 performs projection.

The actuator AC and any of the other elements described above can be omitted. That is, some of the optical elements that constitute the projection lens 40 may be manually moved with a mechanical mechanism including a cam mechanism or the like to adjust the focusing state of the projection lens 40.

The lens driver 83 may change the vertical position or the projection state of the image projected onto the screen SC (see FIG. 2) through tilt adjustment in which the entire projection lens 40 is moved in the upward-downward direction perpendicular to the optical axis OA.

The projection lens 40 according to the embodiment will be specifically described below with reference to FIG. 2. Note that the projection lens 40 shown in FIG. 2 by way of example has the same configuration as the projection lens 40 according to Example 1, which will be described later.

The projection lens 40 according to the embodiment projects an image formed at a projection receiving surface of the liquid crystal panel 29G (29R, 29B) or the image forming unit 20a onto the screen SC. A prism PR corresponding to the cross dichroic prism 31 in FIG. 1 is disposed between the projection lens 40 and the liquid crystal panel 29G (29R, 29B).

The projection lens 40 includes a first lens group G1, which has positive or negative refractive power, an aperture stop ST, and a second lens group G2, which has positive refractive power, sequentially arranged from the side facing the screen SC, which is the enlargement side.

The first lens group G1 includes a negative first lens L1g1, a negative second lens L2g1, a negative third lens L3g1, a positive fourth lens L4g1, and a positive fifth lens L5g1 sequentially arranged from the enlargement side. That is, the first lens group G1 is a combination of five lenses having refractive power, negative, negative, negative, positive, and positive sequentially arranged from the enlargement side. In terms of a lens element, which is the minimum unit, the first lens group G1 includes a first lens L11, a second lens L12, a third lens L13, a fourth lens L14, a fifth lens L15, a sixth lens L16, and a seventh lens L17 sequentially arranged from the enlargement side. The positive fourth lens L4g1 is a cemented lens configured with the fourth lens L14 and the fifth lens L15. The positive fifth lens L5g1 is a cemented lens configured with the sixth lens L16 and the seventh lens L17. That is, the first lens L1g1, the second lens L2g1, and the third lens L3g1 are each a single lens. In the configuration described above, the first lens L1g1, that is, the first lens L11 is a lens having aspherical surfaces on opposite sides.

The first lens group G1 includes a first sub-lens group G1m, which has a negative refractive index, and a second sub-lens group G1p, which has a positive refractive index, sequentially arranged from the enlargement side. The first sub-lens group G1m includes the first lens L1g1, the second lens L2g1, and the third lens L3g1. That is, the first sub-lens group G1m is configured only with the lenses L1g1, L2g1, and L3g1 each having negative refractive power. The second sub-lens group G1p includes the fourth lens L4g1 and the fifth lens L5g1. That is, the second sub-lens group G1p is configured only with the lenses L4g1 and L5g1 each having positive refractive power. In the example shown in FIG. 2, the first lens group G1 has positive refractive power as a whole. The first lens group G1 having positive refractive power allows reduction in the total lens length and the effective diameter. Furthermore, appropriately adjusting the negative refractive power of the first sub-lens group G1m and the positive refractive power of the second sub-lens group G1p in the first lens group G1 allows the projection lens 40 to achieve both size reduction and favorable correction of various aberrations. The refractive power is defined by the reciprocal of the focal length of each lens.

In the first lens group G1, at least one of the third lens L3g1, which is the negative lens closest to the reduction side, and the fourth lens L4g1 and the fifth lens L5g1, which are each a positive lens, is a cemented lens. That is, in the embodiment shown in FIG. 2, the positive fourth lens L4g1 and the positive fifth lens L5g1 are each a cemented lens, and the third lens L3g1 may instead be a cemented lens. Using a cemented lens as described above allows favorable reduction in the chromatic aberration of magnification even in the compact projection lens 40, as described above.

In the first lens group G1, the first lens L1g1 is, but not limited to, a lens having a large change in the amount of sag, and is basically made of a plastic material. The other lenses L2g1 to L5g1 are made of glass materials in consideration of light resistance, but not necessarily.

The second lens group G2 is configured with a negative first lens L1g2, a negative second lens L2g2, a positive third lens L3g2, a negative fourth lens L4g2, a positive fifth lens L5g2, and a positive sixth lens L6g2 sequentially arranged from the enlargement side. That is, the second lens group G2 has a configuration including six lenses having refractive power, negative, negative, positive, negative, positive, and positive sequentially arranged from the enlargement side. In terms of a lens element, which is the minimum unit, the second lens group G2 includes a first lens L21, a second lens L22, a third lens L23, a fourth lens L24, a fifth lens L25, a sixth lens L26, a seventh lens L27, an eighth lens L28, a ninth lens L29, and a tenth lens L30 sequentially arranged from the enlargement side. The negative first lens L1g2 is a cemented lens configured with the first lens L21 and the second lens L22. The positive third lens L3g2 is a cemented lens configured with the fourth lens L24, the fifth lens L25, and the sixth lens L26. The negative fourth lens L4g2 is a cemented lens configured with the seventh lens L27 and the eighth lens L28. That is, the second lens L2g2, the fifth lens L5g2, and the sixth lens L6g2 are each a single lens. In the configuration described above, the second lens L2g2, that is, the third lens L23 is a lens having aspherical surfaces on opposite sides. The second lens group G2 including at least one aspherical lens having negative refractive power can reduce various aberrations such as field curvature.

In the second lens group G2, the first lens L1g2 to the sixth lens L6g2 are made of glass materials in consideration of light resistance, but not necessarily.

Although not shown, the second lens group G2 may have a configuration including five lenses having refractive power, negative, positive, positive, negative, and positive sequentially arranged from the enlargement side (Example 2, which will be described later), or may have a configuration including six lenses having refractive power, positive, negative, positive, positive, negative, and positive sequentially arranged from the enlargement side (Example 3, which will be described later). That is, the second lens group G2 has a basic refractive power configuration of negative, positive, negative, and positive, and a lens having small positive or negative refractive power can be added to the enlargement side of the second lens group G2, or the positive lens following each of the negative lenses can be divided into two.

In terms of the refractive power arrangement of the projection lens 40, in the first lens group G1, the positive fifth lens L5g1 is disposed at a position closest to the reduction side, in the second lens group G2, the first lens L1g2 having negative refractive power is disposed at a position closest to the enlargement side, and the positive lenses L3g2, L5g2, and L6g2 are disposed on the reduction side of the first lens L1g2 having negative refractive power and disposed at a position closest to the enlargement side. Employing the positive-negative-positive refractive power lens configuration as described above allows further reduction in aberrations. As described above, since the first lens group G1 is configured with the negative first sub-lens group G1m and the positive second sub-lens group G1p, it is preferable that a negative lens is provided as the lens closest to the enlargement side in the second lens group G2 in consideration of aberration correction.

Furthermore, in terms of the refractive power arrangement of the projection lens 40, the second lens group G2 includes at least three positive lenses L3g2, L5g2, and L6g2, and the sixth lens L6g2, which is one of the three positive lenses L3g2, L5g2, and L6g2, is disposed at a position closest to the reduction side in the second lens group G2. Arranging the positive lenses at the three separate positions allows reduction in produced aberrations. In addition, the lens disposed at a position closest to the reduction side and having positive refractive power provides the effect of achieving a substantially telecentric configuration as a whole.

The aperture stop ST is a plane that defines the F-number of the projection lens 40, and is a plane located at a position where the principal ray crosses the optical axis OA. A tangible object may be actually disposed as an aperture member, or no aperture member may be disposed.

The projection lens 40 according to the embodiment satisfies the conditional expressions below.

$$\begin{matrix}0.1 < 1 / fg 1 p - 1 / fg 1 m < 0.25 & ( 1 ) \\ ω > 50 & ( 2 ) \\ 2.5 < ( DL 1 \times LL ) \times F / {IH}^{2} < 6.5 & ( 3 ) \\ 3.0 < BF / F < 5.0 & ( 4 )\end{matrix}$$

In Conditional Expressions (1) to (4), the value fg1p is the combined focal length of the first sub-lens group G1m, the value fg1m is the combined focal length of the second sub-lens group G1p, the value w is the maximum half viewing angle of the projection lens 40, the value IH is an image circle, the value DL1 is the effective radius of the lens closest to the screen SC, the value LL is the total length of the projection lens, the value F is the combined focal length of all the lenses, and the value BF is the back focal length in air. Note that the image circle is the height of the beam passing through the tip of the maximum image height at the lens surface of the projection lens 40 that is closest to the enlargement side.

Conditional Expression (1) is an expression for achieving a compact projection lens having favorable resolution. Setting the value of 1/fg1p−1/fg1m in the conditional expression described above at a value greater than to the lower limit allows a wide viewing angle with various aberrations, particularly the chromatic aberrations, advantageously corrected. Setting the value of 1/fg1p−1/fg1m in the conditional expression described above at a value smaller than to the upper limit allows advantageous correction of various aberrations, particularly the chromatic aberrations, with a wide viewing angle achieved.

Conditional Expression (2) shows how to achieve a wide viewing angle of the projection lens 40.

Conditional Expression (3) indicates the lens diameter with respect to the image circle and the overall length, and is an index for size reduction. Setting the value (DL1×LL)×F/IH² in the conditional expression described above at a value greater than to the lower limit allows favorable correction of various aberrations such as field curvature and distortion. Setting the value (DL1×LL)×F/IH² in the conditional expression described above at a value smaller than to the upper limit allows reduction in an increase in the lens diameter, and cost and size reduction.

Conditional expression (4) is an expression for ensuring an appropriate back focal length. Setting the value BF/F in the conditional expression described above at a value greater than to the lower limit can ensure a space for disposing an inserted object such as the prism PR. Setting the value BF/F in the conditional expression described above at a value smaller than to the upper limit can achieve a lens configuration that favorably corrects various aberrations while providing a wide viewing angle.

The projection lens 40 according to the embodiment satisfies the conditional expressions below.

$$\begin{matrix}3.1 < nL 2 g 1 \times nL 3 g 1 & ( 5 ) \\ 0.59 < L 2 θ gf or L 3 θ gf & ( 6 )\end{matrix}$$

In Conditional Expressions (5) and (6), the value nL2g1 is the refractive index of the second lens counted from the enlargement side in the first lens group G1, that is, the second lens L2g1 at the d line, the value L2θgf is a partial dispersion value of the second lens described above (second lens L2g1), the value nL3g1 is the refractive index of the third lens counted from the enlargement side in the first lens group G1, that is, the third lens L3g1 at the d line, and the value L3θgf is a partial dispersion value of the third lens described above (third lens L3g1).

In general, the partial dispersion value θgf is defined by the expression below.

$$Value defined by θ gf = ( Ng - Nf ) / ( Nf - Nc )$$

where
Ng: Refractive index at g line
Nf: Refractive index at f line
Nc: Refractive index at c line

When Conditional Expressions (5) and (6) are satisfied, chromatic aberrations produced by the projection lens 40 can be reduced while the projection lens 40 has a small size and a wide viewing angle.

The projection lens 40 according to the embodiment satisfies the conditional expression below.

$$- 1.2 < fq 1 m / g < - 1.0 \qquad ( 7 )$$

In Conditional Expression (7), the value fg1m is the combined focal length of the second sub-lens group G1p (combined focal length of all negative lenses in first lens group G1), and the value F is the combined focal length of all the lenses.

Setting the value fg1m/F in the conditional expression described above at a value greater than to the lower limit allows a sufficient back focal length to be ensured with various aberrations advantageously reduced. Setting the value fg1m/F in the conditional expression described above at a value smaller than to the upper limit can reduce various aberrations with a sufficient back focal length ensured.

FIG. 3 illustrates focusing operation performed by the projection lens 40 according to the embodiment. Regarding the focusing operation, at least two or more lenses that constitute the first lens group G1 are moved in the same direction along the optical axis OA. The focusing operation can therefore be performed with the field curvature favorably corrected when the projection distance is changed. In the example shown in FIG. 3, the first lens group G1 includes a first focusing group FG1 and a second focusing group FG2. The first focusing group FG1 is configured with the second lens L2g1 to the fourth lens L4g1, and the second focusing group FG2 is configured with the fifth lens L5g1. When the projection position is changed from a far position to a near position, the first lens group G1 is moved temporarily toward the enlargement side and then toward the reduction side, and the second focusing group FG2 is moved only toward the enlargement side. The focusing operation is, however, not necessarily performed as shown in FIG. 3. Instead, for example, the first lens L1g1 to the fourth lens L4g1 of the first lens group G1 may be the first focusing group, and the fifth lens L5g1 may be the second focusing group. Still instead, the second lens L2g1 of the first lens group G1 may be the first focusing group, the third lens L3g1 and the fourth lens L4g1 may be the second focusing group, and the fifth lens L5g1 may be a third focusing group.

As described above, the projection lens 40 according to the embodiment is configured with the first lens group G1, which has positive or negative refractive power, the aperture stop, and the second lens group G2, which has positive refractive power, sequentially arranged from the enlargement side, with the first lens group G1 configured with the first sub-lens group G1m, which has a negative refractive index, and the second sub-lens group G1p, which has a positive refractive index, sequentially arranged from the enlargement side, and the projection lens 40 satisfies the conditional expressions below.

$$\begin{matrix}0.1 < 1 / fg 1 p - 1 / fg 1 m < 0.25 & ( 1 ) \\ ω > 50 & ( 2 ) \\ 2.5 < ( DL 1 \times LL ) \times F / {IH}^{2} < 6.5 & ( 3 ) \\ 3.0 < BF / F < 5.0 & ( 4 )\end{matrix}$$

In Conditional Expressions (1) to (4), the value fg1p is the combined focal length of the first sub-lens group G1m, the value fg1m is the combined focal length of the second sub-lens group G1p, the value w is the maximum half viewing angle of the projection lens, the value IH is the image circle, the value DL1 is the effective radius of the lens closest to the screen, the value LL is the total length of the projection lens, the value F is the combined focal length of all the lenses, and the value BF is the back focal length in air.

In the projection lens 40 described above, appropriately adjusting the negative refractive power of the first sub-lens group G1m and the positive refractive power of the second sub-lens group G1p in the first lens group G1 allows the projection lens 40 to achieve both size reduction and favorable correction of various aberrations. In particular, the first lens group G1 having positive refractive power allows reduction in the total lens length and the effective diameter. When Conditional Expressions (1) to (4) are satisfied, a compact projection lens having a wide viewing angle and favorable resolution can be achieved with an appropriate back focal length ensured.

The projection apparatus 2 described above includes the projection lens 40 described above and the image forming unit 20a, which forms a projection image in the reduction-side conjugate plane RC of the projection lens 40, and the image forming unit 20a includes the light source apparatus 10 and the light modulators OM, which modulate the light from the light source apparatus 10. The size of the projection apparatus 2 including the projection lens 40 can thus be reduced.

### EXAMPLES

Examples of the projection lens 40 will be described below. The meanings of parameters common to Examples 1 to 3 described below are summarized below.
R Radius of curvature
D Axial inter-surface distance (lens thickness or inter-lens distance)
Nd Refractive Index at d line
Vd Abbe number at d line
DL Lens diameter

An aspherical surface is specified by the polynomial (aspherical surface expression) below.

$$z = \frac{{ch}^{2}}{1 + \sqrt{1 - ( k + 1 ) {c}^{2} {h}^{2}}} + Σ {A}_{i} {h}^{i}$$

where
c: Curvature (1/R)
H: Height from optical axis
k: Conic constant of aspherical surface
Ai: high-order aspherical coefficient of aspherical surface

The surface number 0 means the image plane (projection receiving surface) on the screen SC, STO means the aperture stop ST, INF means infinity, and the last surface number means the display surface, for example, of the liquid crystal panel 29G. A surface number followed by “*” indicates an aspherical surface.

### Example 1

Data on the lens surfaces in Example 1 are shown in Table 1 below.

TABLE 1

| Surface number | R | D | Nd | Vd | DL |
|---|---|---|---|---|---|
| 0 | | Variable 1 | | | |
| 1* | −11.3599 | 4.386822 | 1.535037 | 55.7 | 35.21467 |
| 2* | −22.0291 | Variable 2 | | | 24.76318 |
| 3 | 35.5076 | 1.2 | 1.903659 | 31.3 | 18.71956 |
| 4 | 14.24023 | 13.20791 | | | 13.26067 |
| 5 | −35.1455 | 4.117401 | 1.72916 | 54.7 | 12.3022 |
| 6 | 44.91622 | 2.637517 | | | 11.69227 |
| 7 | 75.90936 | 10.14208 | 1.6727 | 31.1 | 12 |
| 8 | −18.1594 | 1.2 | 2.001 | 29.1 | 11.68956 |
| 9 | −27.9899 | Variable 3 | | | 12 |
| 10 | 38.91473 | 10 | 1.592701 | 35.3 | 11.6 |
| 11 | −17.629 | 1.2 | 2.001 | 29.1 | 10.65539 |
| 12 | −25.079 | 0.5 | | | 10.79873 |
| 13STO | INF | 0.830188 | | | 9.531606 |
| 14 | −73.3449 | 2.755345 | 1.910822 | 35.3 | 9.507041 |
| 15 | 12.35393 | 7.879494 | 1.808095 | 22.8 | 9.52856 |
| 16 | −8.5018E+3 | 1.480487 | | | 9.811811 |
| 17* | −31.2815 | 1.269549 | 1.51633 | 64.1 | 9.899212 |
| 18* | −49.8173 | 0.15 | | | 10.7 |
| 19 | 39.01397 | 7.24514 | 1.496999 | 81.6 | 10.76345 |
| 20 | −20.4555 | 1.2 | 1.953749 | 32.3 | 10.92799 |
| 21 | 91.33022 | 7.629593 | 1.496999 | 81.6 | 11.91 |
| 22 | −19.6921 | 0.2 | | | 12.6 |
| 23 | −868.528 | 1.2 | 2.001 | 29.1 | 13.73117 |
| 24 | 30.88643 | 7.914476 | 1.48749 | 70.2 | 14.34479 |
| 25 | −51.5769 | 0.1 | | | 15.22188 |
| 26 | 75.27753 | 6.502286 | 1.496999 | 81.6 | 17.34157 |
| 27 | −55.1305 | 0.1 | | | 17.66078 |
| 28 | 138.4343 | 7.459241 | 1.48749 | 70.2 | 18.24151 |
| 29 | −38.2797 | 1 | | | 18.31672 |
| 30 | INF | 30.69 | 1.516798 | 64.2 | 17.1191 |
| 31 | INF | 8.985093 | | | 12.90079 |

Table 2 below shows an example of the movement of the focusing lenses in the focusing operation in Example 1. “Variable 1” means the axial inter-surface distance from the screen SC to the first lens L1g1 of the first lens group G1. “Variable 2” means the axial inter-surface distance from the first lens L1g1 to the second lens L2g1 of the first focusing group FG1. “Variable 3” means the axial inter-surface distance from the fourth lens L4g1 of the first focusing group FG1 to the fifth lens L5g1 of the second focusing group FG2.

TABLE 2

| Variable 1 | Variable 2 | Variable 3 |
|---|---|---|
| 640 | 10.013 | 17.754 |
| 906 | 9.770 | 17.663 |
| 1270 | 9.572 | 17.602 |
| 1380 | 9.650 | 17.577 |

Table 3 below shows the aspherical coefficients of the lens surfaces in Example 1. In Table 3 and the tables shown below, a number to the power of 10 (1.00×10⁺¹⁸, for example) is expressed by using E (1.00E+18, for example).

TABLE 3

| Surface | | | | | | | |
|---|---|---|---|---|---|---|---|
| number | K | A4 | A5 | A6 | A7 | A8 | A9 |
| 1 | −5.5043E+00 | 1.3374E−03 | −3.4730E−05 | −8.1789E−09 | 1.1034E−08 | 3.2123E−10 | −1.2359E−11 |
| 2 | −1.9912E+01 | 1.1467E−03 | 7.9764E−05 | −6.2684E−06 | 7.8212E−08 | 6.1753E−09 | −1.4514E−10 |

| Surface | | | | | | |
|---|---|---|---|---|---|---|
| number | A10 | A11 | A12 | A13 | A14 | A15 |
| 1 | 5.2033E−14 | −5.4867E−17 | −5.6451E−17 | 3.2394E−18 | −8.3012E−21 | −4.9489E−22 |
| 2 | −8.8148E−13 | −5.2935E−14 | −1.1461E−15 | 1.0105E−16 | | |

| Surface | | | | | |
|---|---|---|---|---|---|
| number | K | A1 | A2 | A3 | A4 |
| 17 | −5.8178E+00 | 1.4983E−04 | −1.4916E−06 | 5.6793E−09 | −1.3130E−11 |
| 18 | 1.4085E+01 | 1.9533E−04 | −1.3108E−06 | 4.0419E−09 | −4.7318E−12 |

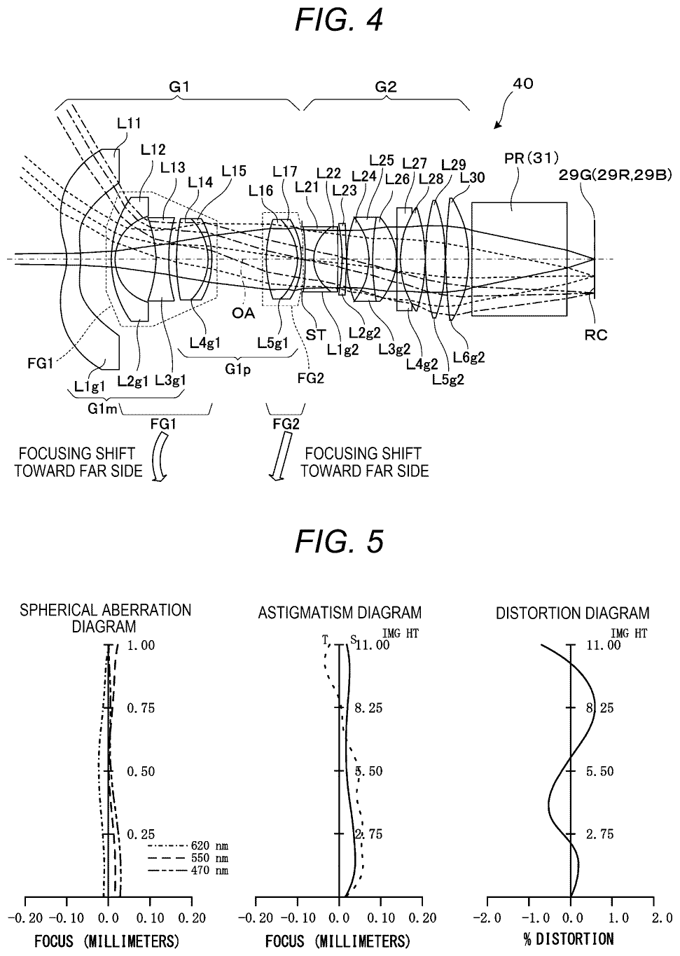

FIG. 4 is a cross-sectional view of the projection lens 40 according to Example 1. The projection lens 40 shown in FIG. 4 corresponds to the projection lens 40 according to the first embodiment.

The projection lens 40 enlarges an image on the display surface, for example, of the liquid crystal panel 29G at a magnification according to the distance to the screen SC and projects the enlarged image. The F-number of the projection lens 40 is 1.64.

The projection lens 40 includes the first lens group G1, which has positive refractive power, the aperture stop ST, and the second lens group G2, which has positive refractive power, sequentially arranged from the side facing the screen SC, which is the enlargement side, and the reduction side of the projection lens 40 is a substantially telecentric system.

The first lens group G1 includes the negative first lens L1g1, the negative second lens L2g1, the negative third lens L3g1, the positive fourth lens L4g1, and the positive fifth lens L5g1 sequentially arranged from the enlargement side. That is, the first lens group G1 is a combination of five lenses having refractive power, negative, negative, negative, positive, and positive sequentially arranged from the enlargement side. The first lens L1g1 is a single lens configured only with the first lens L11, and is a negative aspherical lens made of plastic. The second lens L2g1 is a negative meniscus single lens configured only with the second lens L12, and the third lens L3g1 is a biconcave single lens configured only with the third lens L13. The fourth lens L4g1 is a cemented lens that is the combination of the positive biconvex fourth lens L14 and the negative meniscus fifth lens L15. The fifth lens L5g1 is a cemented lens that is the combination of the positive biconvex sixth lens L16 and the negative meniscus seventh lens L17.

The second lens group G2 is configured with the negative first lens L1g2, the negative second lens L2g2, the positive third lens L3g2, the negative fourth lens L4g2, the positive fifth lens L5g2, and the positive sixth lens L6g2 sequentially arranged from the enlargement side. That is, the second lens group G2 has a configuration including six lenses having refractive power, negative, negative, positive, negative, positive, and positive sequentially arranged from the enlargement side. The first lens L1g2 is a cemented lens that is the combination of the negative biconcave first lens L21 and the positive biconvex second lens L22. The second lens L2g2 is a single lens configured only with the third lens L23, and is an aspherical negative meniscus lens made of molded glass. The third lens L3g2 is a cemented lens that is the combination of the positive biconvex fourth lens L24, the negative biconcave fifth lens L25, and the positive biconvex sixth lens L26. The fourth lens L4g2 is a cemented lens that is the combination of the negative biconcave seventh lens L27 and the positive biconvex eighth lens L28. The fifth lens L5g2 is a biconvex single lens configured only with the ninth lens L29, and the sixth lens L6g2 is a biconvex single lens configured only with the tenth lens L30.

In the focusing operation, the first focusing group FG1 configured with the second lens L2g1, the third lens L3g1, and the fourth lens L4g1 moves toward the enlargement side and then toward the reduction side, whereas the second focusing group FG2 configured only with the fifth lens L5g1 moves in one direction toward the enlargement side.

FIG. 5 shows the characteristics of longitudinal aberrations (that is, characteristics of spherical aberration, astigmatism, and distortion) of the projection lens 40 according to Example 1.

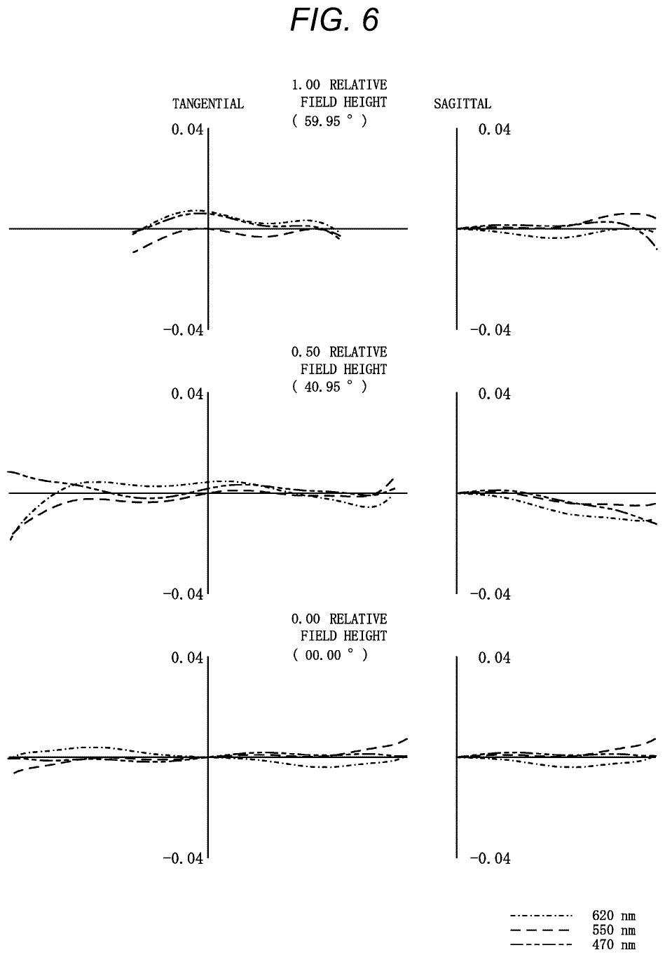

FIG. 6 shows the characteristics of lateral aberrations (characteristics of tangential and sagittal aberrations at three relative image heights of 1.0, 0.5, and 0.1) of the projection lens 40 according to Example 1.

### Example 2

Data on the lens surfaces in Example 2 are shown in Table 4 below.

TABLE 4

| Surface number | R | D | Nd | Vd | DL |
|---|---|---|---|---|---|
| 0 | | Variable 1 | | | |
| 1* | −13.2957 | 1.9379 | 1.5350 | 55.7 | 23.08 |
| 2* | −27.4494 | 6.0000 | | | 18.87 |
| 3 | 32.7803 | 1.2000 | 2.0010 | 29.1 | 16.39 |
| 4 | 15.2848 | 10.3868 | | | 12.73 |
| 5 | −29.6199 | 1.0000 | 2.0010 | 29.1 | 12.07 |
| 6 | 17.0000 | 7.8077 | 1.8052 | 25.4 | 11.95 |
| 7 | −60.2319 | 0.1000 | | | 12.11 |
| 8 | −79.1855 | 6.4264 | 1.6398 | 34.4 | 12.11 |
| 9 | −15.4518 | 1.7139 | 1.7292 | 54.6 | 12.20 |
| 10 | −37.2466 | Variable 2 | | | 12.86 |
| 11 | 44.3732 | 6.2372 | 1.5163 | 64.1 | 12.64 |
| 12 | −57.6254 | Variable 3 | | | 12.31 |
| 13STO | INF | 19.8659 | | | 10.77 |
| 14* | −82.0104 | 2.6286 | 1.8088 | 40.9 | 10.14 |
| 15* | −5.2991E+3 | 5.6433 | | | 10.20 |
| 16 | 50.3247 | 3.7430 | 1.8697 | 20 | 12.24 |
| 17 | −84.9098 | 1.7786 | | | 12.29 |
| 18 | −119.5998 | 1.2000 | 1.9537 | 32.3 | 12.15 |
| 19 | 29.5162 | 9.1840 | 1.4875 | 70.2 | 12.22 |
| 20 | −20.3785 | 0.2000 | | | 12.60 |
| 21 | 39.9087 | 1.0000 | 2.0010 | 29.1 | 12.71 |
| 22 | 18.9392 | 11.7268 | 1.5174 | 52.4 | 12.18 |
| 23 | −16.5651 | 1.2000 | 2.0010 | 29.1 | 12.27 |
| 24 | −66.2727 | 0.1000 | | | 13.72 |
| 25 | −605.1143 | 7.5058 | 1.4875 | 70.2 | 14.20 |
| 26 | −20.8503 | 1.0000 | | | 14.60 |
| 27 | INF | 27.0520 | 1.5168 | 64.2 | 13.85 |
| 32 | INF | 8.9410 | | | 11.96 |

Table 5 below shows an example of the movement of the focusing lenses in the focusing operation in Example 2. “Variable 1” means the axial inter-surface distance from the screen SC to the first lens L1g1 of the first focusing group FG1. “Variable 2” means the axial inter-surface distance from the fourth lens L4g1 of the first focusing group FG1 to the fifth lens L5g1 of the second focusing group FG2, and “Variable 3” means the axial inter-surface distance from the fifth lens L5g1 to the aperture stop ST.

TABLE 5

| Variable 1 | Variable 2 | Variable 3 |
|---|---|---|
| 640 | 16.083 | 3.286 |
| 906 | 16.019 | 3.633 |
| 1270 | 15.974 | 3.912 |
| 1380 | 15.965 | 3.948 |

Table 6 below shows the aspherical coefficients of the lens surfaces in Example 2.

TABLE 6

| Surface | | | | | | | |
|---|---|---|---|---|---|---|---|
| number | K | A4 | A5 | A6 | A7 | A8 | A9 |
| 1 | −9.9355E+00 | 2.1859E−03 | −4.7136E−05 | −9.6137E−07 | 1.6932E−08 | 1.3830E−09 | 1.1156E−11 |
| 2 | −5.5429E+01 | 2.1857E−03 | 7.2818E−05 | −7.0166E−06 | 5.9860E−08 | 5.1486E−09 | −1.6499E−10 |

| Surface | | | | | | |
|---|---|---|---|---|---|---|
| number | A10 | A11 | A12 | A13 | A14 | A15 |
| 1 | 3.4235E−13 | −2.1159E−14 | −1.6193E−15 | −4.3853E−17 | 9.2938E−20 | 1.4293E−19 |
| 2 | −3.1002E−13 | −4.2487E−14 | −1.6340E−15 | 6.2934E−17 | | |

| Surface | | | | | | | |
|---|---|---|---|---|---|---|---|
| number | K | A1 | A2 | A3 | A4 | A5 | A6 |
| 14 | 9.3122E+00 | 3.2227E−05 | −9.4929E−08 | −5.6015E−10 | 5.3903E−12 | −2.1957E−14 | |
| 15 | 1.0000E+02 | 4.6173E−05 | −4.0661E−08 | −5.8274E−10 | 5.1885E−12 | −1.9464E−14 | |

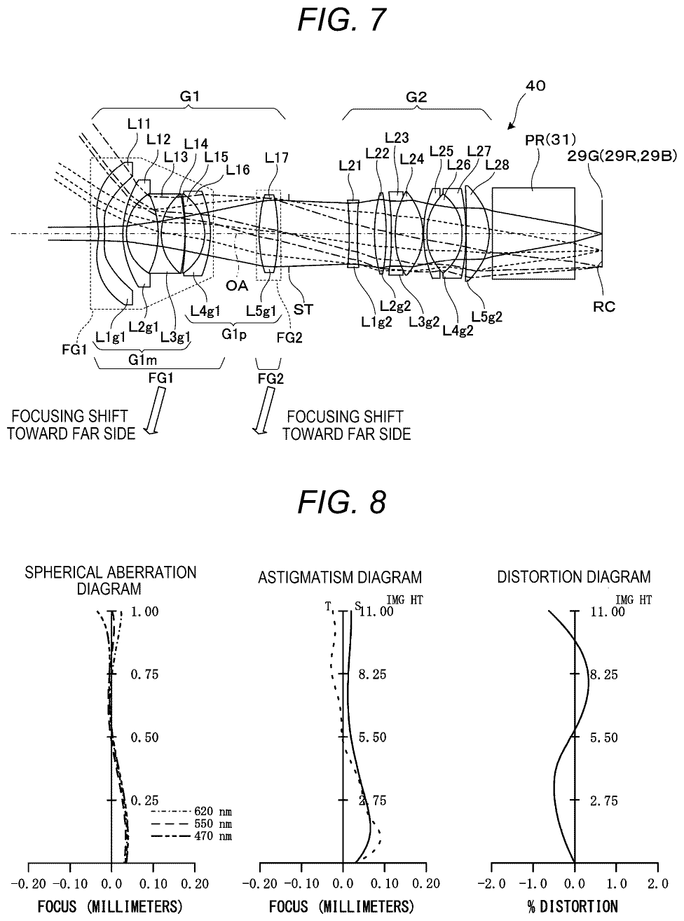

FIG. 7 is a cross-sectional view of the projection lens 40 according to Example 2. The projection lens 40 enlarges an image on the display surface, for example, of the liquid crystal panel 29G at a magnification according to the distance to the screen SC and projects the enlarged image. The F-number of the projection lens 40 is 1.84.

The projection lens 40 includes the first lens group G1, which has positive refractive power, the aperture stop ST, and the second lens group G2, which has positive refractive power, sequentially arranged from the side facing the screen SC, which is the enlargement side, and the reduction side of the projection lens 40 is a substantially telecentric system.

The first lens group G1 includes the negative first lens L1g1, the negative second lens L2g1, the negative third lens L3g1, the positive fourth lens L4g1, and the positive fifth lens L5g1 sequentially arranged from the enlargement side. That is, the first lens group G1 is a combination of five lenses having refractive power, negative, negative, negative, positive, and positive sequentially arranged from the enlargement side. The first lens L1g1 is a single lens configured only with the first lens L11, and is a negative aspherical lens made of plastic. The second lens L2g1 is a negative meniscus single lens configured only with the second lens L12, and the third lens L3g1 is a cemented lens that is the combination of the negative biconcave third lens L13 and the positive biconvex fourth lens L14. The fourth lens L4g1 is a cemented lens that is the combination of the positive meniscus fifth lens L15 and the negative meniscus sixth lens L16. The fifth lens L5g1 is a biconvex single lens configured only with the seventh lens L17.

The second lens group G2 includes the negative first lens L1g2, the positive second lens L2g2, the positive third lens L3g2, the negative fourth lens L4g2, and the positive fifthlens L5g2 sequentially arranged from the enlargement side. That is, the second lens group G2 has a configuration including five lenses having refractive power, negative, positive, positive, negative, and positive sequentially arranged from the enlargement side. The first lens L1g2 is a single lens configured only with the first lens L21, and is a negative biconcave aspherical lens made of molded glass. The second lens L2g2 is a positive biconvex single lens configured only with the second lens L22. The third lens L3g2 is a cemented lens that is the combination of the negative biconcave third lens L23 and the positive biconvex fourth lens L24. The fourth lens L4g2 is a cemented lens that is the combination of the negative meniscus fifth lens L25, the positive biconvex sixth lens L26, and the negative meniscus seventh lens L27. The sixth lens L6g2 is a positive meniscus single lens configured only with the eighth lens L28.

In the focusing operation, the first focusing group FG1 configured with the first lens L1g1, the second lens L2g1, the third lens L3g1, and the fourth lens L4g1 moves in one direction toward the enlargement side, and the second focusing group FG2 configured only with the fifth lens L5g1 also moves in one direction toward the enlargement side.

FIG. 8 shows the characteristics of the longitudinal aberrations (that is, characteristics of spherical aberration, astigmatism, and distortion) of the projection lens 40 according to Example 2.

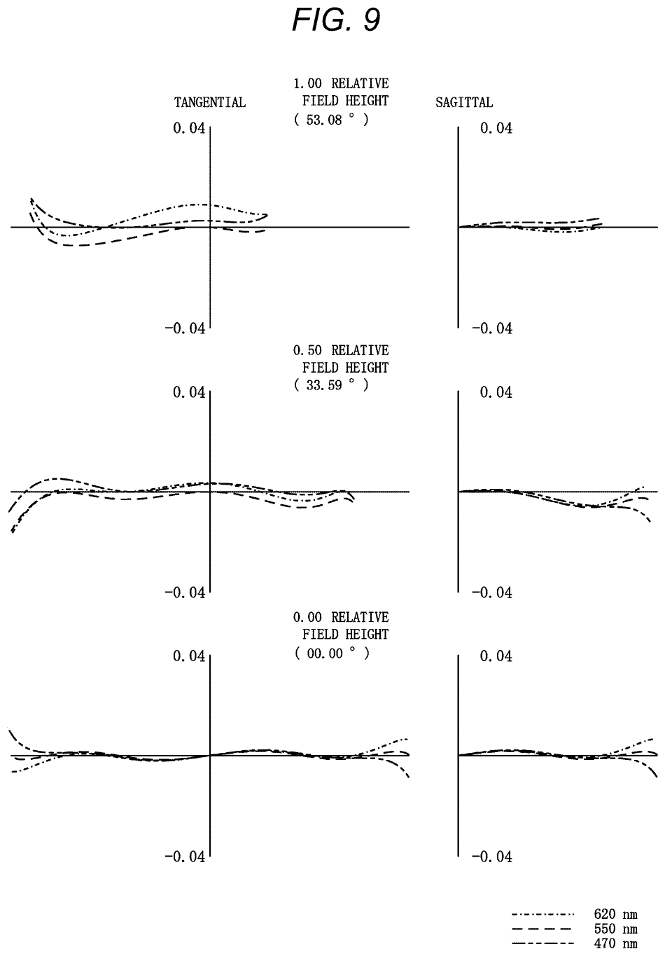

FIG. 9 shows the characteristics of the lateral aberrations (characteristics of tangential and sagittal aberrations at three relative image heights of 1.0, 0.5, and 0.1) of the projection lens 40 according to Example 2.

### Example 3

Data on the lens surfaces in Example 3 are shown in Table 7 below.

TABLE 7

| Surface number | R | D | Nd | Vd | DL |
|---|---|---|---|---|---|
| 0 | | Variable 1 | | | |
| 1* | −13.0586 | 4.728 | 1.535037 | 55.7 | 34.72 |
| 2* | −34.0552 | Variable 2 | | | 24.22 |
| 3 | 79.8793 | 1.593 | 1.72916 | 54.6 | 20.39 |
| 4 | 16.9770 | Variable 3 | | | 14.17 |
| 5 | −27.3511 | 1.000 | 2.001 | 29.1 | 11.56 |
| 6 | 21.2210 | 5.510 | 1.688931 | 31 | 11.55 |
| 7 | −160.7270 | 1.089 | | | 11.75 |
| 8 | 54.0756 | 4.246 | 1.784723 | 25.6 | 12.22 |
| 9 | −52.3136 | Variable 4 | | | 12.20 |
| 10 | 33.1808 | 8.452 | 1.761821 | 26.5 | 11.42 |
| 11 | −17.7414 | 1.200 | 2.001 | 29.1 | 10.96 |
| 12 | 329.5325 | Variable 5 | | | 10.72 |
| 13STO | −48.7040 | 3.668 | 1.48749 | 70.2 | 10.58 |
| 14 | −19.3367 | 0.100 | | | 10.80 |
| 15* | −62.2138 | 1.200 | 1.80882 | 40.9 | 10.52 |
| 16* | 673.4890 | 5.899 | | | 10.60 |
| 17 | −394.8201 | 2.600 | 1.869663 | 20.2 | 11.63 |
| 18 | −57.4933 | 0.150 | | | 11.82 |
| 19 | 521.4513 | 4.740 | 1.808095 | 22.7 | 11.88 |
| 20 | −29.9808 | 1.200 | 1.953749 | 32.3 | 11.91 |
| 21 | 44.0813 | 9.108 | 1.48749 | 70.2 | 12.16 |
| 22 | −19.6604 | 0.200 | | | 12.60 |
| 23 | 60.5556 | 1.000 | 2.001 | 29.1 | 12.61 |
| 24 | 20.6087 | 11.190 | 1.539956 | 59.4 | 12.27 |
| 25 | −18.2387 | 1.200 | 2.001 | 29.1 | 12.50 |
| 26 | −50.2672 | 0.100 | | | 13.69 |
| 27 | 112.7047 | 7.642 | 1.48749 | 70.2 | 14.50 |
| 28 | −24.6300 | 1.000 | | | 14.80 |
| 29 | INF | 30.690 | 1.516798 | 64.2 | 14.16 |
| 30 | INF | 9.255 | | | 12.01 |

Table 8 below show an example of the movement of the focusing lenses in the focusing operation in Example 3. “Variable 1” means the axial inter-surface distance from the screen SC to the first lens L1g1 of the first lens group G1. “Variable 2” means the axial inter-surface distance from the first lens L1g1 to the second lens L2g1 of the first focusing group FG1. “Variable 3” means the axial inter-surface distance from the second lens L2g1 to the third lens L3g1 of the second focusing group FG2. “Variable 4” means the axial inter-surface distance from the fourth lens L4g1 of the second focusing group FG2 to the fifth lens L5g1 of a third focusing group FG3. “Variable 5” means the axial inter-surface distance from the fifth lens L5g1 to the aperture stop ST.

TABLE 8

| Variable 1 | Variable 2 | Variable 3 | Variable 4 | Variable 5 |
|---|---|---|---|---|
| 640 | 10.436 | 13.939 | 14.428 | 3.378 |
| 906 | 10.374 | 14.078 | 14.200 | 3.529 |
| 1270 | 10.335 | 14.157 | 14.055 | 3.635 |
| 1380 | 10.340 | 14.144 | 14.051 | 3.646 |

Table 9 below shows the aspherical coefficients of the lens surfaces in Example 3.

TABLE 9

| Surface | | | | | | | |
|---|---|---|---|---|---|---|---|
| number | K | A4 | A5 | A6 | A7 | A8 | A9 |
| 1 | −4.9260E+00 | 1.5877E−03 | −4.6383E−05 | −4.3286E−08 | 2.2909E−08 | 2.0705E−10 | −2.1960E−11 |
| 2 | −1.4484E+01 | 1.5484E−03 | 7.5643E−05 | −6.4076E−06 | 7.7362E−08 | 5.3840E−09 | −1.6847E−10 |

| Surface | | | | | | |
|---|---|---|---|---|---|---|
| number | A10 | A11 | A12 | A13 | A14 | A15 |
| 1 | 1.9795E−13 | 5.1193E−15 | −9.3632E−17 | 1.1911E−18 | −5.6524E−20 | 1.1557E−21 |
| 2 | −3.8239E−13 | −2.7496E−14 | −4.7668E−16 | 8.3173E−17 | | |

| Surface | | | | | | |
|---|---|---|---|---|---|---|
| number | K | A1 | A2 | A3 | A4 | A5 |
| 15 | 2.0584E+01 | 2.4597E−05 | 4.4584E−08 | −1.4799E−09 | 7.7762E−12 | −1.6061E−14 |
| 16 | −3.9152E+04 | 5.1386E−05 | −7.3235E−08 | −2.6736E−10 | 1.5147E−12 | −9.3397E−15 |

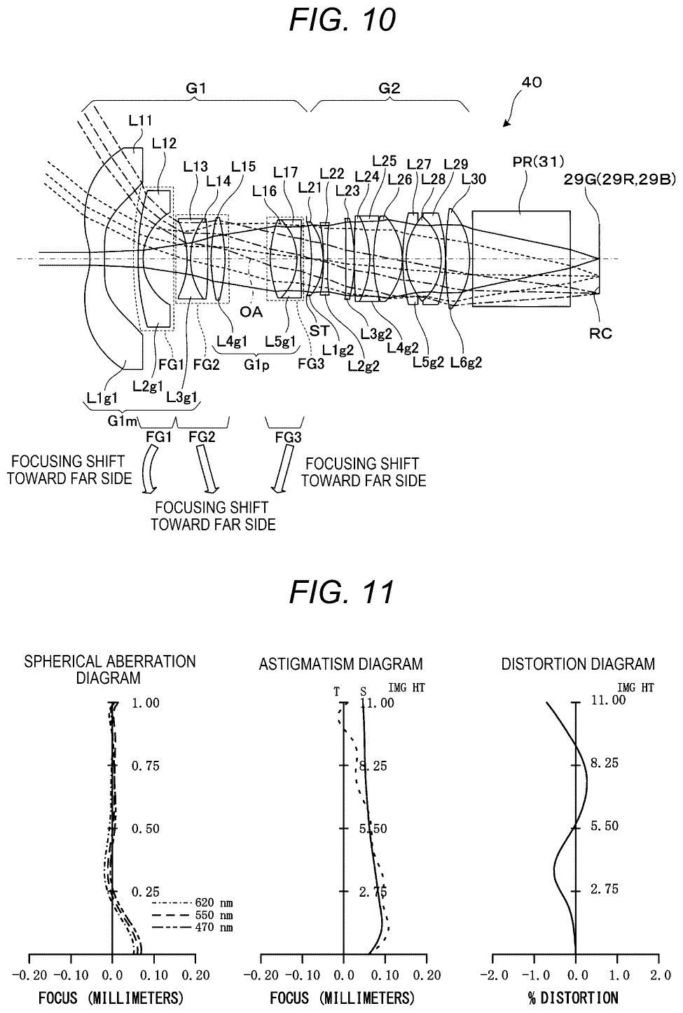

FIG. 10 is a cross-sectional view of the projection lens 40 according to Example 3. The projection lens 40 enlarges an image on the display surface, for example, of the liquid crystal panel 29G at a magnification according to the distance to the screen SC and projects the enlarged image. The F-number of the projection lens 40 is 1.61.

The projection lens 40 includes the first lens group G1, which has negative refractive power, the aperture stop ST, and the second lens group G2, which has positive refractive power, sequentially arranged from the side facing the screen SC, which is the enlargement side, and the reduction side of the projection lens 40 is a substantially telecentric system. Note that the aperture stop ST is provided on a lens surface in the second lens group G2.

The first lens group G1 includes the negative first lens L1g1, the negative second lens L2g1, the negative third lens L3g1, the positive fourth lens L4g1, and the positive fifth lens L5g1 sequentially arranged from the enlargement side. That is, the first lens group G1 is a combination of five lenses having refractive power, negative, negative, negative, positive, and positive sequentially arranged from the enlargement side. The first lens L1g1 is a single lens configured only with the first lens L11, and is a negative aspherical lens made of plastic. The second lens L2g1 is a negative meniscus single lens configured only with the second lens L12. The third lens L3g1 is a cemented lens that is the combination of the negative biconcave third lens L13 and the positive biconvex fourth lens L14. The fourth lens L4g1 is a positive biconvex single lens configured only with the fifth lens L15. The fifth lens L5g1 is a cemented lens that is the combination of the positive biconvex sixth lens L16 and the negative biconcave seventh lens L17.

The second lens group G2 is configured with the positive first lens L1g2, the negative second lens L2g2, the positive third lens L3g2, the positive fourth lens L4g2, the negative fifth lens L5g2, and the positive sixth lens L6g2 sequentially arranged from the enlargement side. That is, the second lens group G2 has a configuration including six lenses having refractive power, positive, negative, positive, positive, negative, and positive sequentially arranged from the enlargement side. The first lens L1g2 is a positive meniscus single lens configured only with the first lens L21. The second lens L2g1 is a single lens configured only with the second lens L22, and is a negative biconcave aspherical lens made of molded glass. The third lens L3g2 is a positive meniscus single lens configured only with the third lens L23. The fourth lens L4g2 is a cemented lens that is the combination of the positive biconvex fourth lens L24, the negative biconcave fifth lens L25, and the positive biconvex sixth lens L26. The fifth lens L5g2 is a cemented lens that is the combination of the negative meniscus seventh lens L27, the positive biconvex eighth lens L28, and the negative meniscus ninth lens L29. The sixth lens L6g2 is a positive biconvex single lens configured only with the tenth lens L30.

In the focusing operation, the first focusing group FG1 configured only with the second lens L2g1 moves toward the enlargement side and then toward the reduction side. The second focusing group FG2 configured with the third lens L3g1 and the fourth lens L4g1 moves in one direction toward the reduction side, and the third focusing group FG3 configured only with the fifth lens L5g1 moves in one direction toward the enlargement side.

FIG. 11 shows the characteristics of the longitudinal aberrations (that is, characteristics of spherical aberration, astigmatism, and distortion) of the projection lens 40 according to Example 3.

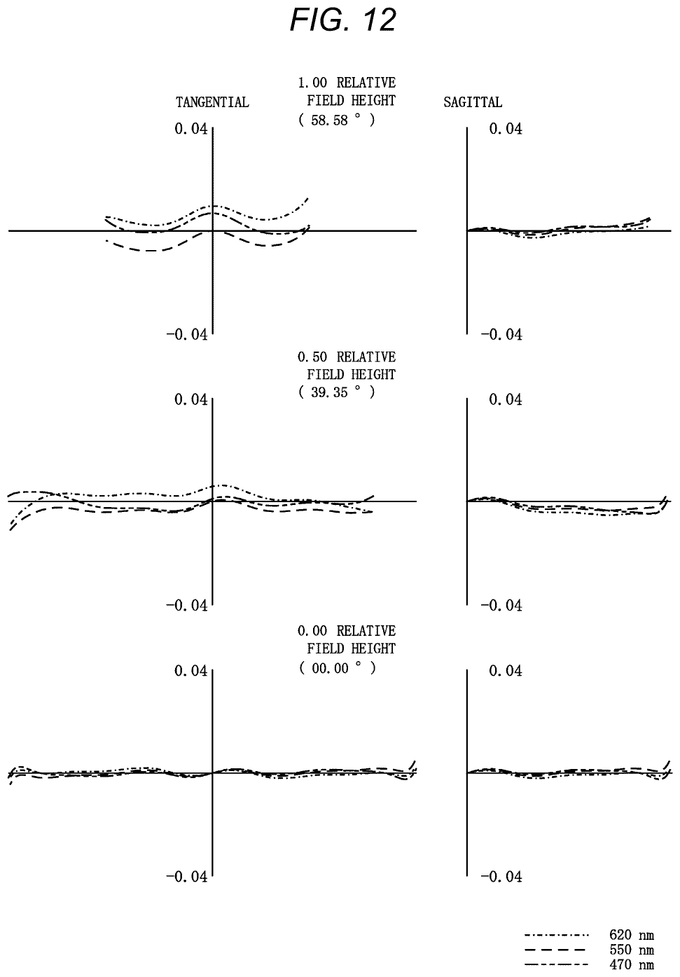

FIG. 12 shows the characteristics of the lateral aberrations (characteristics of tangential and sagittal aberrations at three relative image heights of 1.0, 0.5, and 0.1) of the projection lens 40 according to Example 3.

For reference, Table 10 below shows Examples 1 to 3 corresponding to Conditional Expressions (1) to (7), and Examples 1 to 5 in JP-A-2014-190999 as Comparative Examples.

TABLE 10

| | Present embodiment | | | JP-A-2014-190999 | | | | |
|---|---|---|---|---|---|---|---|---|
| | Example | Example | Example | Example | Example | Example | Example | Example |
| | 1 | 2 | 3 | 1 | 2 | 3 | 4 | 5 |
| Value 1/fg1p − | 0.195 | 0.135 | 0.217 | 0.112 | 0.13 | 0.143 | 0.167 | 0.123 |
| 1/fg1m in | | | | | | | | |
| Conditional | | | | | | | | |
| Expression (1) | | | | | | | | |
| Value ω in | 60.0 | 53.0 | 58.6 | 62.3 | 61.4 | 52.3 | 59.2 | 59.6 |
| Conditional | | | | | | | | |
| Expression (2) | | | | | | | | |
| Value (DL1*LL) * | 239 | 203 | 231 | 449 | 340 | 413 | 415 | 457 |
| F/IH\hat{ }2 in | | | | | | | | |
| Conditional | | | | | | | | |
| Expression (3) | | | | | | | | |
| Value BF/F in | 4.8 | 3.4 | 4.6 | 4.7 | 5.0 | 4.0 | 4.0 | 4.3 |
| Conditional | | | | | | | | |
| Expression (4) | | | | | | | | |
| Value nL2fg1 * | 3.3 | 4.0 | 3.5 | 2.7 | 2.8 | 2.8 | 2.7 | 2.7 |
| nL3fg1 in | | | | | | | | |
| Conditional | | | | | | | | |
| Expression (5) | | | | | | | | |
| Value L2θgf in | 0.5963 | 0.5997 | 0.5459 | 0.5427 | 0.5458 | 0.5458 | 0.5457 | 0.5300 |
| Conditional | | | | | | | | |
| Expression (6) | | | | | | | | |
| Value L3θgf in | 0.5459 | 0.5997 | 0.5997 | 0.5888 | 0.5869 | 0.5869 | 0.6161 | 0.5864 |
| Conditional | | | | | | | | |
| Expression (6) | | | | | | | | |
| Value fg1m/F in | −1.00 | −1.10 | −0.83 | −1.89 | −1.43 | −1.22 | −1.13 | −1.51 |
| Conditional | | | | | | | | |
| Expression (7) | | | | | | | | |

### Other Items

The structure described above is presented by way of example, and can be changed in various manners to the extent that the same functions can be achieved.

For example, in each of Examples, one or more lenses having substantially no power can be added to each of the lens groups G1 and G2 at each of positions upstream and downstream from the lenses that constitute the lens group.

Furthermore, a target to be enlarged and projected by the projection lens 40 is not limited to an image formed by a liquid crystal panel, and an image formed by a light modulator such as a digital micromirror device can be enlarged and projected.

### Summary of Present Disclosure

The present disclosure will be summarized below as additional remarks.

### Additional Remark 1

A projection lens including:
a first lens group having positive or negative refractive power; an aperture stop; and a second lens group having positive refractive power that are sequentially arranged from an enlargement side,
wherein the first lens group is configured with a first sub-lens group having a negative refractive index and a second sub-lens group having a positive refractive index that are sequentially arranged from the enlargement side, and
the projection lens satisfies conditional expressions below,

$$\begin{matrix}0.1 < 1 / fg 1 p - 1 / fg 1 m < 0.25 & ( 1 ) \\ ω > 50 & ( 2 ) \\ 2.5 < ( DL 1 \times LL ) \times F / {IH}^{2} < 6.5 & ( 3 ) \\ 3.0 < BF / F < 5.0 & ( 4 )\end{matrix}$$

where
fg1p: Combined focal length of first sub-lens group,
fg1m: Combined focal length of second sub-lens group,
ω: Maximum half viewing angle of projection lens,
IH: Image circle,
DL1: Effective radius of lens closest to screen,
LL: Total lens length,
F: Combined focal length of all lenses, and
BF: Back focal length in air.

In the thus configured projection lens, appropriately adjusting the negative refractive power of the first sub-lens group and the positive refractive power of the second sub-lens group in the first lens group allows the projection lens 40 to achieve both size reduction and favorable correction of various aberrations. In particular, the first lens group having positive refractive power allows reduction in the total lens length and the effective diameter. When Conditional Expressions (1) to (4) are satisfied, a compact projection lens having a wide viewing angle and favorable resolution can be achieved with an appropriate back focal length ensured.

Conditional Expression (1) is an expression for achieving a compact projection lens having favorable resolution. Setting the value of 1/fg1p−1/fg1m in the conditional expression described above at a value greater than to the lower limit allows a wide viewing angle with various aberrations, particularly the chromatic aberrations, advantageously corrected. Setting the value of 1/fg1p−1/fg1m in the conditional expression described above at a value smaller than to the upper limit allows advantageous correction of various aberrations, particularly the chromatic aberrations, with a wide viewing angle achieved.

Conditional Expression (2) shows how to achieve a wide viewing angle of the projection lens.

Conditional Expression (3) indicates the lens diameter with respect to the image circle and the overall length, and is an index for size reduction. Setting the value (DL1×LL)×F/IH² in the conditional expression described above at a value greater than to the lower limit allows favorable correction of various aberrations such as field curvature and distortion. Setting the value (DL1×LL)×F/IH² in the conditional expression described above at a value smaller than to the upper limit allows reduction in an increase in the lens diameter, and cost and size reduction.

Conditional expression (4) is an expression for ensuring an appropriate back focal length. Setting the value BF/F in the conditional expression described above at a value greater than to the lower limit can ensure a space for disposing an inserted object such as a prism. Setting the value BF/F in the conditional expression described above at a value smaller than to the upper limit can achieve a lens configuration that favorably corrects various aberrations while providing a wide viewing angle.

### Additional Remark 2

The projection lens according to Additional Remark 1, wherein
in the first lens group, a positive lens is disposed at a position closest to the reduction side, and
in the second lens group, a lens having negative refractive power is disposed at a position closest to the enlargement side, and a positive lens is disposed on the reduction side of the lens disposed at a position closest to the enlargement side and having negative refractive power.

Employing the positive-negative-positive refractive power lens configuration as described above allows further reduction in aberrations.

### Additional Remark 3

The projection lens according to any one of Additional Remarks 1 and 2, wherein the second lens group includes at least three positive lenses, and one of the three positive lenses is disposed at a position closest to the reduction side in the second lens group.

Arranging the positive lenses at three separate positions as described above allows reduction in produced aberrations. In addition, the lens disposed at a position closest to the reduction side and having positive refractive power provides the effect of achieving a substantially telecentric configuration as a whole.

### Additional Remark 4

The projection lens according to any one of Additional Remarks 1 to 3, wherein the second lens group includes at least one aspherical lens having negative refractive power.

Various aberrations such as field curvature can thus be reduced.

### Additional Remark 5

The projection lens according to any one of the Additional Remarks 1 to 4, satisfying conditional expressions below,

$$\begin{matrix}3.1 < nL 2 g 1 \times nL 3 g 1 & ( 5 ) \\ 0.59 < L 2 θ gf or L 3 θ gf & ( 6 )\end{matrix}$$

where
nL2g1: Refractive index of second lens counted from enlargement side in first lens group at d line,
L2θgf: Partial dispersion value of second lens described above,
nL3g1: Refractive index of third lens counted from enlargement side in first lens group at d line, and
L3θgf: Partial dispersion value of third lens described above.

When Conditional Expressions (5) and (6) are satisfied, chromatic aberrations of the projection lens can be reduced with the projection lens having a small size and a wide viewing angle.

### Additional Remark 6

The projection lens according to any one of the Additional Remarks 1 to 5, satisfying a conditional expression below,

$$- 1.2 < fq 1 m / g < - 1.0 \qquad ( 7 )$$

Setting the value fg1m/F in the conditional expression described above at a value greater than to the lower limit allows a sufficient back focal length to be ensured with various aberrations advantageously reduced. Setting the value fg1m/F in the conditional expression described above at a value smaller than to the upper limit can reduce various aberrations with a sufficient back focal length ensured.

### Additional Remark 7

The projection lens according to any one of Additional Remarks 1 to 6, wherein
single lenses or cemented lenses having refractive power, negative, negative, negative, positive, and positive sequentially arranged from the enlargement side are disposed in the first lens group, and
at least one of the negative lens closest to the reduction side or the two positive lenses is a cemented lens.

Using the cemented lens as described above allows favorable reduction in the chromatic aberration of magnification even in the compact projection lens, as described above.

### Additional Remark 8

The projection lens according to any one of Additional Remarks 1 to 7, wherein at least two or more focusing lens groups in the first lens group move in the same direction along an optical axis during focusing operation.

The focusing operation can therefore be performed with the field curvature favorably corrected when the projection distance is changed.

### Additional Remark 9

A projection apparatus including:
the projection lens according to any one of Additional Remarks 1 to 8; and
an image forming unit configured to form a projection image in a reduction-side conjugate plane of the projection lens,
wherein the image forming unit includes a light source apparatus and a light modulator configured to modulate light from the light source apparatus.

The size of the projection apparatus including the projection lens can thus be reduced.

What is claimed is:

1. A projection lens comprising:
a first lens group having positive or negative refractive power; an aperture stop; and a second lens group having positive refractive power that are sequentially arranged from an enlargement side,
wherein the first lens group is configured with a first sub-lens group having a negative refractive index and a second sub-lens group having a positive refractive index that are sequentially arranged from the enlargement side, and
the projection lens satisfies conditional expressions below,
$$\begin{matrix}0.1 < 1 / fg 1 p - 1 / fg 1 m < 0.25 & ( 1 ) \\ ω > 50 & ( 2 ) \\ 2.5 < ( DL 1 \times LL ) \times F / {IH}^{2} < 6.5 & ( 3 ) \\ 3.0 < BF / F < 5.0 & ( 4 )\end{matrix}$$
in Conditional Expressions (1) to (4),
fg1p: Combined focal length of first sub-lens group described above,
fg1m: Combined focal length of the second sub-lens group described above,
ω: Maximum half viewing angle of projection lens described above,
IH: Image circle,
DL1: Effective radius of lens closest to screen,
LL: Total lens length,
F: Composite focal length of all lenses, and
BF: Back focal length in air.

2. The projection lens according to claim 1, wherein
in the first lens group, a positive lens is disposed at a position closest to a reduction side, and
in the second lens group, a lens having negative refractive power is disposed at a position closest to the enlargement side, and a positive lens is disposed on the reduction side of the lens disposed at a position closest to the enlargement side and having negative refractive power.

3. The projection lens according to claim 1, wherein
the second lens group includes at least three positive lenses, and one of the three positive lenses is disposed at a position closest to the reduction side in the second lens group.

4. The projection lens according to claim 1, wherein
the second lens group includes at least one aspherical lens having negative refractive power.

5. The projection lens according to claim 1,
satisfying conditional expressions below,
$$\begin{matrix}3.1 < nL 2 g 1 \times nL 3 g 1 & ( 5 ) \\ 0.59 < L 2 θ gf or L 3 θ gf & ( 6 )\end{matrix}$$
in Conditional Expressions (5) and (6),
nL2g1: Refractive index of second lens counted from enlargement side in first lens group described above at d line,
L2θgf: Partial dispersion value of second lens described above described above,
nL3g1: Refractive index of third lens counted from enlargement side in first lens group described above at d line, and
L3θgf: Partial dispersion value of third lens described above.

6. The projection lens according to claim 1,
satisfying a conditional expression below,
$$- 1.2 < fq 1 m / g < - 1.0 . \qquad ( 7 )$$

7. The projection lens according to claim 1, wherein
single lenses or cemented lenses having refractive power, negative, negative, negative, positive, and positive sequentially arranged from the enlargement side are disposed in the first lens group, and
at least one of the negative lens closest to the reduction side or the two positive lenses is a cemented lens.

8. The projection lens according to claim 1, wherein
at least two or more focusing lens groups in the first lens group move in a same direction along an optical axis during focusing operation.

9. A projection apparatus comprising:
the projection lens according to claim 1; and
an image forming unit configured to form a projection image in a reduction-side conjugate plane of the projection lens,
wherein the image forming unit includes a light source apparatus and a light modulator configured to modulate light from the light source apparatus.
